(19) United States
(12) Patent Application Publication
(10) Pub. No.: US 2017/0289322 A1
(43) Pub. Date: Oct. 5, 2017

(54) System and Method for a Dynamic Mobile Web Server Fallback

(71) Applicant: Vertical Computer Systems, Inc., Richardson, TX (US)

(72) Inventor: Luiz Claudio Valdetaro, Richardson, TX (US)

(73) Assignee: Vertical Computer Systems, Inc., Richardson, TX (US)

(21) Appl. No.: 15/295,876

(22) Filed: Oct. 17, 2016

Related U.S. Application Data
(63) Continuation-in-part of application No. 13/491,372, filed on Jun. 7, 2012.
Application No. 13/491,372 is a continuation-in-part of application No. 12/966,741, filed on Dec. 13, 2010, now Pat. No. 9,112,832.
(60) Provisional application No. 62/242,164, filed on Oct. 15, 2015.
(60) Provisional application No. 61/494,407, filed on Jun. 7, 2011.

(51) Int. Cl. H04L 29/14; H04L 29/08; G06F 11/07; G06F 17/30; H04L 12/911

(52) U.S. Cl. CPC H04L 69/40; G06F 17/30861; H04L 47/74; G06F 11/07; H04L 67/2814; H04L 61/15

(57) ABSTRACT

A relay server is coupled to a URL database within an open firewall. First and second Internet devices are configured for communication with the relay server and include respective first and second websites behind closed firewalls, wherein the second website is operative as a “fallback” website to the first website. A web browser on a client Internet device is connected to the relay server. The relay server is provided with software to facilitate communication between the web browser and the first Internet device website so that if the first Internet device website goes offline, the relay server will connect the web browser to the fallback website on the second Internet device.

### RELATED APPLICATION INFORMATION

This application claims the benefit of application Ser. No. 62/242,164 filed Oct. 15, 2015, and is a continuation-in-part (CIP) application of prior application Ser. No. 13/491,372 filed Jun. 7, 2012, which is a continuation-in-part (CIP) application of prior application Ser. No. 12/966,741 filed Dec. 13, 2010, now U.S. Pat. No. 9,112,832 and which claimed the benefit of application Ser. No. 61/494,407 filed Jun. 7, 2011, all of which applications are hereby incorporated herein by reference, in their entirety.

### TECHNICAL FIELD

The invention relates generally to communications and, more particularly, to mobile web server communications.

### BACKGROUND

When a mobile web server in an internet device (such as a phone) goes offline and, for example, the phone goes through a tunnel or the user is far removed from a cell antenna, the website of that mobile web server is effectively offline and cannot be accessed. Furthermore, if there are a plurality of web servers using the same Internet Protocol (IP) address, but only one of them goes offline, there is no simple way to switch that single inaccessible one.

There is prior art software that allows fallback of websites, such as, for example, a load balancer. A load balancer will detect that a web server is offline and redirect a Hypertext Transfer Protocol (HTTP) request to another web server. A problem arises, though, that if that second web server is at a different network, and possibly behind a closed firewall, at a different location, it becomes impossible to redirect the HTTP request to another web server. Also, if there are a plurality of domain names pointing to a single IP address, and only one of the web servers related to a single domain goes offline, a load balancer can only switch all websites to a new IP, not a single website.

Another prior art solution utilizes a dynamic Domain Name Server (DNS). A dynamic DNS translates the domain name into an IP address, and if the first web server is offline, the dynamic DNS could direct the first web server to another IP address. This, however, cannot occur in real time. Furthermore, if there are many websites hosted by that web server, all websites would have to move to the new IP address.

### SUMMARY

The present invention, accordingly, provides a relay server coupled to a URL database within an open firewall. First and second Internet devices are configured for communication with the relay server and include respective first and second websites behind closed firewalls, wherein the second website is operative as a “fallback” website to the first website. A web browser on a client Internet device is connected to the relay server. The relay server is provided with software to facilitate communication between the web browser and the first Internet device website so that if the first Internet device website goes offline, the relay server will connect the web browser to the fallback website on the second Internet device.

### BRIEF DESCRIPTION OF THE DRAWING

For a more complete understanding of the present invention, and the advantages thereof, reference is now made to the following descriptions taken in conjunction with the accompanying drawings, in which:

FIG. 1 is a schematic view exemplifying a communication system embodying features of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. Additionally, as used herein, the term “substantially” is to be construed as a term of approximation.

It is noted that, unless indicated otherwise, all functions described herein may be performed by a processor such as a microprocessor, a controller, a microcontroller, an application-specific integrated circuit (ASIC), an electronic data processor, a computer, or the like, in accordance with code, such as program code, software, integrated circuits, and/or the like that are coded to perform such functions. Furthermore, it is considered that the design, development, and implementation details of all such code would be apparent to a person having ordinary skill in the art based upon a review of the present description of the invention.

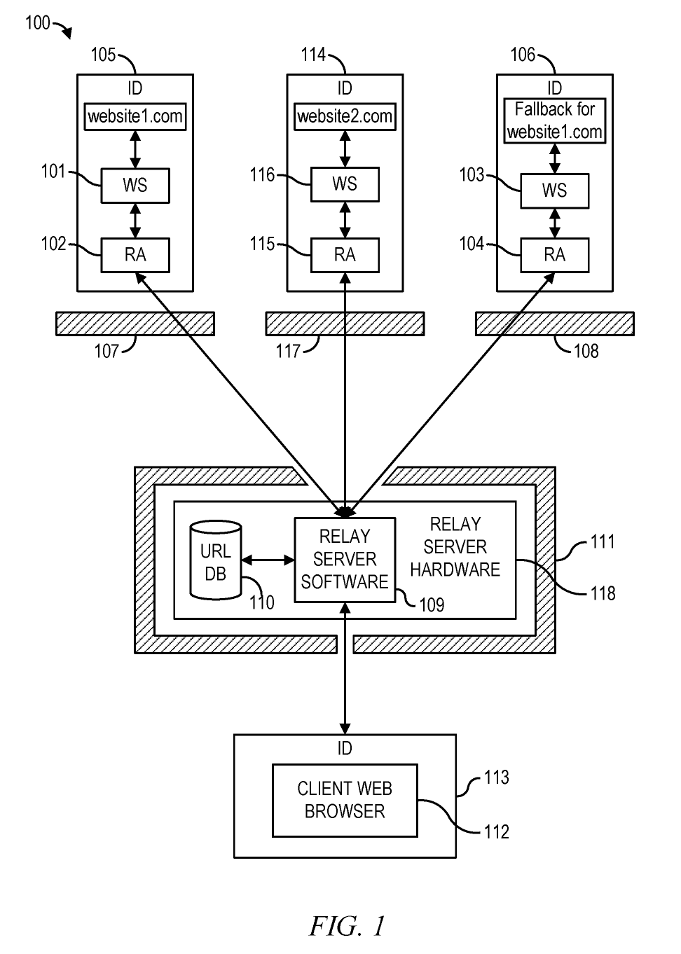

Referring to FIG. 1 (“the FIGURE”), the reference numeral 100 generally designates a communication system embodying features of both the prior art and the present invention. Accordingly, system 100 includes three Internet devices (IDs) 105, 106, and 114 with respective web server (WS) software 101, 103, and 116. ID 105 hosts a website exemplified as website1.com, and ID 106 hosts a “fallback” (i.e., a hot stand-by) for website1.com. ID 114 hosts a website exemplified as website2.com, not integral to the invention, but as shown below, is provided to illustrate how, in the prior art, when a website does not have a fallback, an http request may fail. All three IDs 105, 106, and 114 may be at different geographic locations and have dynamic IP addresses.

All three IDs 105, 106, and 114 are made available through their respective Relay Agent (RA) software 102, 104, and 115, plus the Relay Server (RS) software 109, as depicted in patent application Ser. No. 13/491,372, filed Jun. 7, 2012, incorporated herein in its entirety by reference.

As depicted in the FIGURE, RAs 102 and 115 log into RS 109. RA 102 logs into RS 109 informing RS 109 that it (RA 102) hosts website1.com, and RA 115 logs into RS 109 informing RS 109 that it (RA 115) hosts website2.com. However, RA 104 logs into RS 109 a little differently, because it uses the same credentials as RA 102, but with the difference of informing RS 109 that it (RA 102) is the standby fallback for RA 102. RS 109 then stores that information (that RA 104 is a fallback for RA 102) in a URL database 110.

In operation, by way of example, a user utilizing ID 113 may send a web request (and HTTP request) to website1.com. The DNS for website1.com translates to the IP address of Relay Server (RS) hardware 118, and RS 109 receives the request. Then, as depicted in the '372 patent, RS 109 sends the request to RA 102, which sends the request to web server 101, which responds back to RA 102, which sends the response to RS 109, which sends the response back to web browser software 112 (the HTTP client).

The same sequence occurs if the user decides to access website2.com. The user utilizing ID 113 would send a web request (and HTTP request) to website2.com. Since the DNS for website2.com translates to the IP address of the RS 118, RS 109 receives that request. Then it sends the request to RA 115, which sends the request to web server 116, which responds back to RA 115, which sends the response to RS 109, which sends the response back to the web browser software 112.

However, if ID 105 becomes inaccessible (e.g., goes offline) and the user tries to access website1.com, the request would not be able to be sent to RA 102, because it is offline. In such a case, RS 109 would consult the URL database 110 to check if there is an alternate RA for website1.com. In this case, it would determine that RA 104 is such an alternate (or “fallback”), and RS 109 would then route the HTTP request to RA 104, which would route the request to the web server 103, which would respond back to RA 104, which would respond back to RS 109, which would send back the response to the web browser 112, and the user would never notice that ID 105 was offline.

In contrast to ID 105, if the prior art ID 114 becomes inaccessible (e.g., goes offline) and the user tries to access website2.com, the request would fail because ID 114 has no fallback. Accordingly, it is understood that ID 114 is provided for purposes of contrasting the prior art, but does not constitute any necessary portion of the invention.

In the above example, both websites (website1.com and website2.com) have the same IP address publicly, which is the IP address of the RS 118. When ID 105 fails, all the requests for website1.com are fulfilled by ID 106.

It is understood that the present invention may take many forms and embodiments. Accordingly, several variations may be made in the foregoing without departing from the spirit or the scope of the invention. For example, in addition to the HTTP protocol, the invention may be readily adapted for use with other protocols, such as HTTPS, FTP, SFTP, RAW, Gopher, and the like.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A system for a dynamic mobile web server fallback, the system comprising:
a relay server contained within an open firewall;
a URL database coupled to the relay server within the open firewall;
a first Internet device having a first relay agent configured for communication with the relay server, the first Internet device further including first web server software coupled to the first relay server for operating a first website behind a closed firewall;
a second Internet device having a second relay agent configured for communication with the relay server, the second Internet device further including second web server software coupled to the second relay server for operating a fallback website behind a closed firewall;
a web browser on an Internet device, the web browser being connected to the relay server; and
wherein the relay server is provided with software to facilitate communication between the web browser and the first Internet device website so that if the first Internet device website goes offline, the web browser will connect to the fallback.

2. A method for a dynamic mobile web server fallback, the system comprising a relay server provided with software to facilitate communication between a web browser and a first Internet device website behind a closed firewall so that if the first Internet device website goes offline, the web browser will connect to a fallback behind a closed firewall
